(19) United States
(12) Patent Application Publication
(10) Pub. No.: US 2026/0353089 A1
(43) Pub. Date: Nov. 5, 2026

(54) Personal electronic device for detecting and responding to wireless surveillance signals via threat classification, suppression logic, and secure data transmission

(71) Applicant: Serhii Nikolaichuk, Austin, TX (US)

(72) Inventor: Serhii Nikolaichuk, Austin, TX (US)

(21) Appl. No.: 19/260,580

(22) Filed: Jul. 6, 2025

Related U.S. Application Data
(60) Provisional application No. 63/798,670, filed on May 2, 2025.

(51) Int. Cl. H04W 12/122; G01S 7/537

(52) U.S. Cl. CPC H04W 12/122; G01S 7/537

(57) ABSTRACT

A portable electronic device configured to detect, classify, and provide countermeasures against wireless surveillance signals. The device includes a microcontroller with wireless capability, a Bluetooth Low Energy (BLE) scanner, a radio frequency (RF) receiver (433/868 MHz), an NFC reader, a vibration motor, and an LED indicator. It further includes modules for acoustic masking via ultrasonic waves and for deploying targeted, protocol-conformant countermeasures. It continuously monitors for malicious wireless signals, such as BLE trackers, analog RF bugs, or unauthorized NFC scans. Upon detection, it alerts the user through vibration and LED feedback and transmits threat data via BLE to a paired mobile application. A Shield Mode can be activated manually or remotely to deploy said countermeasures, which are designed to induce device-native safety responses in threat devices without generating harmful interference. Logged events are encrypted and stored locally, with optional synchronization to the mobile app. The system complies with FCC and CE emission standards and operates within a rechargeable, pocket-sized USB-C housing. The firmware is modular, supporting OTA updates and adaptive behavior based on environmental context and user profiles.

### 2. CROSS-REFERENCE TO RELATED APPLICATIONS

This application claims the benefit of U.S. Provisional Patent Application No. 63/798,670, filed on May 2, 2025, the entire contents of which are hereby incorporated by reference.

### 3. CROSS-REFERENCE TO RELATED APPLICATIONS

This application claims the benefit of U.S. Provisional Patent Application No. 63/798,670, filed on May 2, 2025, the entire contents of which are hereby incorporated by reference.

### 4. FIELD OF THE INVENTION

The present invention relates to the field of personal electronic devices designed for the detection, classification, and responding to potentially privacy-invasive surveillance signals utilizing wireless technologies.

More specifically, the invention pertains to portable multifunctional devices that integrate BLE, radio frequency, and NFC scanning modules, and include protocol-conformant countermeasure functionality, operable within regulatory limits, to induce device-native safety responses in unwanted wireless tracking devices.

The invention is particularly applicable in environments where individuals are at risk of being tracked or monitored using consumer-grade wireless technologies, such as Bluetooth-based beacons, analog RF transmitters, and NFC-enabled proximity readers.

### 5. BACKGROUND OF THE INVENTION/PRIOR ART

With the advancement of wireless technologies, the risks associated with covert or unsolicited digital surveillance have significantly increased.

In everyday life, there is a growing number of cases involving covert tracking through the use of Bluetooth-based devices (e.g., Apple AirTag, Tile), analog RF transmitters (“bugs”), NFC-enabled proximity readers, and concealed Wi-Fi or BLE-enabled cameras.

Such devices are frequently employed in hotel rooms, rental properties, vehicles, and office environments to gather information about a person's location, movement, or behavior without their knowledge or consent.

Several categories of protective equipment exist on the market, including:
broadband signal emitters (often illegal, power-intensive, and bulky);
RF spectrum scanners (primarily designed for military or industrial use);
optical devices to locate hidden cameras; and
single-mode detectors that are limited to one signal type (e.g., only BLE, or only RF).

Existing solutions exhibit major limitations, including:
lack of portability or compact integration into a personal accessory;
inability to simultaneously detect and classify multiple types of surveillance threats (BLE, RF, NFC);
absence of intelligent active countermeasure mechanisms within legally permissible emission thresholds;
no integration with mobile applications or real-time visualization interfaces; and
complexity of operation and pricing models inaccessible to non-technical users.

Furthermore, no known prior art provides a unified, self-contained, subscription-controlled device that integrates scanning, analysis, protocol-conformant countermeasures, acoustic masking, vibration alerting, logging, and mobile BLE connectivity in a compact form factor suitable for personal carry (e.g., key fob).

Accordingly, there exists a clear and unmet need for a legally compliant, user-accessible personal device that combines passive threat detection and active countermeasures across multiple wireless channels.

### 6. SUMMARY OF THE INVENTION

The present invention provides a portable electronic system configured to detect, classify, and provide protocol-conformant countermeasures against wireless signals associated with covert or privacy-invasive digital surveillance.

The system comprises a microcontroller with wireless communication capability, a Bluetooth Low Energy (BLE) scanner, a radio frequency (RF) receiver operable at 433 MHZ and/or 868 MHz, and a near-field communication (NFC) reader module.

Additional components include a vibration motor, an LED indicator, an ultrasonic emitter, and a control button.

Power is provided by a rechargeable lithium-ion battery regulated to 3.3 volts and chargeable via a USB-C interface.

In a standard detection mode, the device continuously monitors the surrounding environment for BLE trackers, analog RF transmitters, and unsolicited NFC activity.

Upon identifying a potential threat, the system initiates a user alert via vibration and/or visual indication and may transmit event data to a mobile application via a secured BLE link.

Detected signal data is optionally logged in encrypted form within non-volatile memory and may be synchronized with the mobile application upon reestablishment of connection.

The device further includes a Shield Mode, selectively activated either manually or via the mobile application, which deploys acoustic masking via ultrasonic signals in the 20-24 kHz range and/or protocol-conformant countermeasures. These countermeasures are designed to induce device-native safety responses in external surveillance devices without generating harmful interference.

Emission modules are configured to comply with U.S. and EU regulatory thresholds (FCC Part 15 and CE EN 300 328) to ensure lawful operation in domestic and international contexts.

The system is implemented in a compact enclosure suitable for personal carry and is designed to support firmware upgrades, modular signal-processing pipelines, and context-aware operational logic that adapts device behavior based on environmental inputs, battery level, and user-selected scenarios.

### 7. BRIEF DESCRIPTION OF THE DRAWINGS

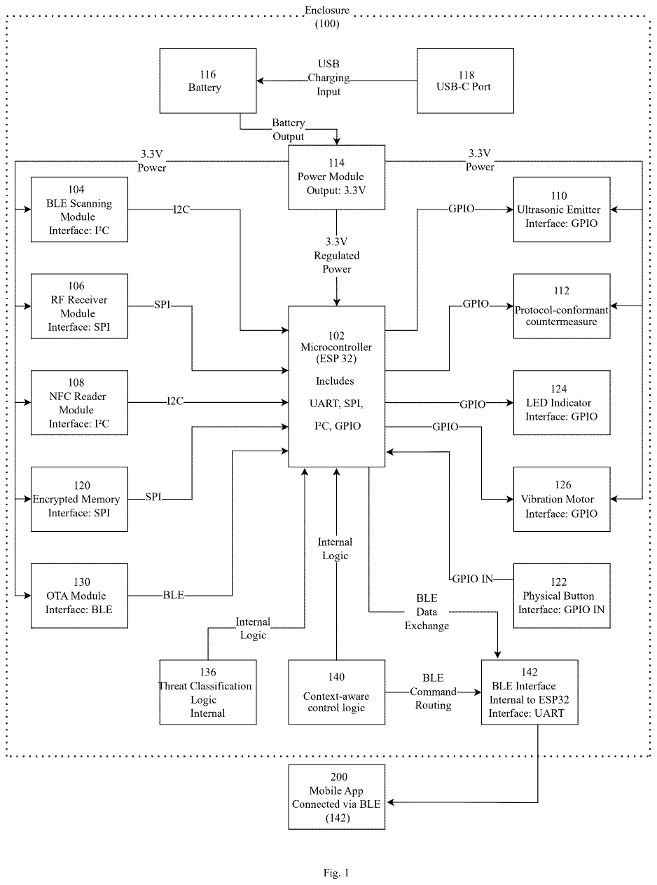

### FIG. 1

A combined functional and interface block diagram of the device, illustrating all key hardware components and their electrical/logical interconnections, including microcontroller 102, BLE scanner 104, RF receiver 106, NFC reader 108, ultrasonic emitter 110, protocol-conformant countermeasure module 112, power 114, battery 116, USB-C 118, memory 120, control button 122, LED 124, motor 126, update module 130, signal filtering logic 138, classification logic 136, context-aware control logic 140, and BLE interface 142.

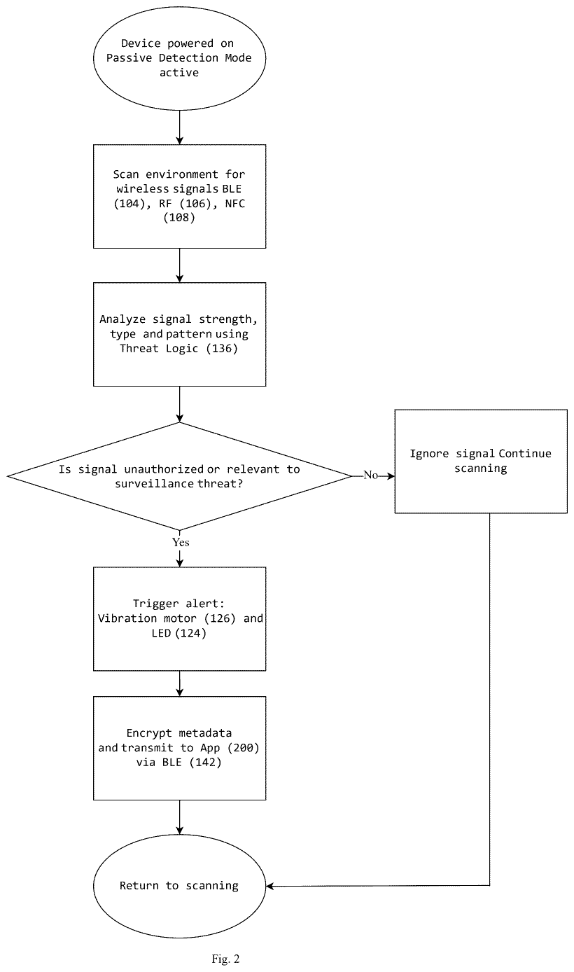

### FIG. 2

A logic flow diagram for passive threat detection mode. Illustrates signal scanning by modules 104, 106, and 108, real-time signal classification via logic 136, local alerting through LED 124 and motor 126, and encrypted metadata transmission to mobile application 200 via BLE 142.

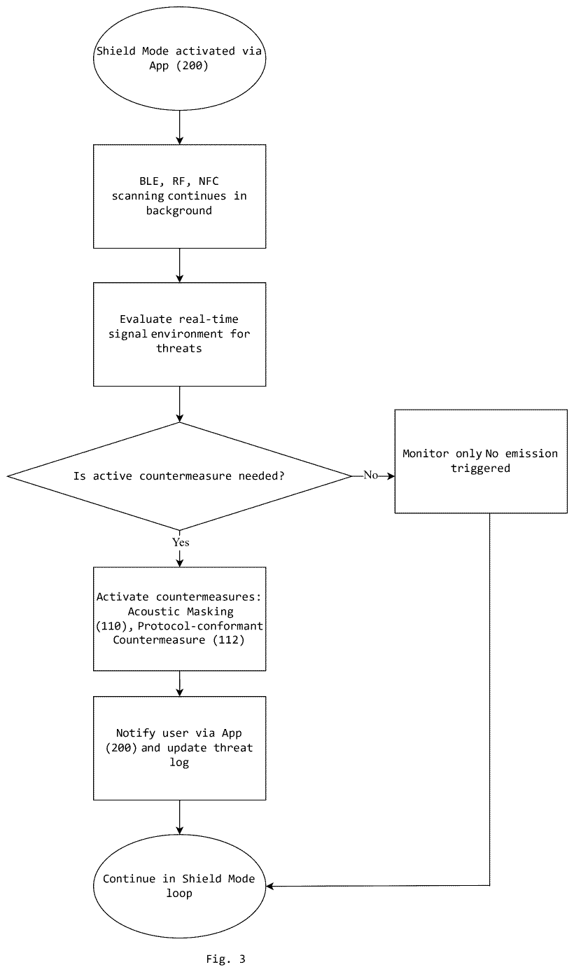

### FIG. 3

An operational logic diagram of Shield Mode activation and countermeasure deployment. Shows triggering via button 122 or remote BLE signal from app 200, followed by activation of ultrasonic emitter 110 and protocol-conformant countermeasure module 112, with power regulation via module 114 and context-aware control logic handled by 102 and 140.

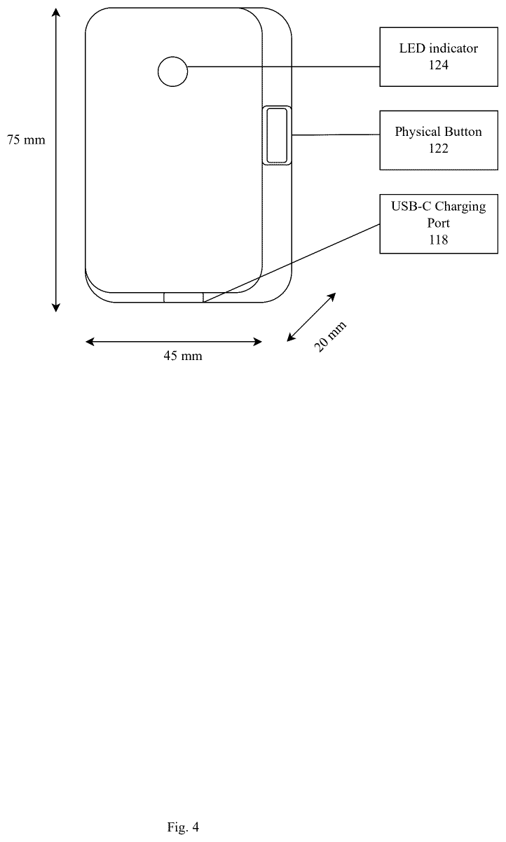

### FIG. 4

An external isometric view of the device enclosure 100 in key-fob format, illustrating placement of the control button 122, LED indicator 124, USB-C charging port 118, and approximate dimensions of 75×45×20 mm.

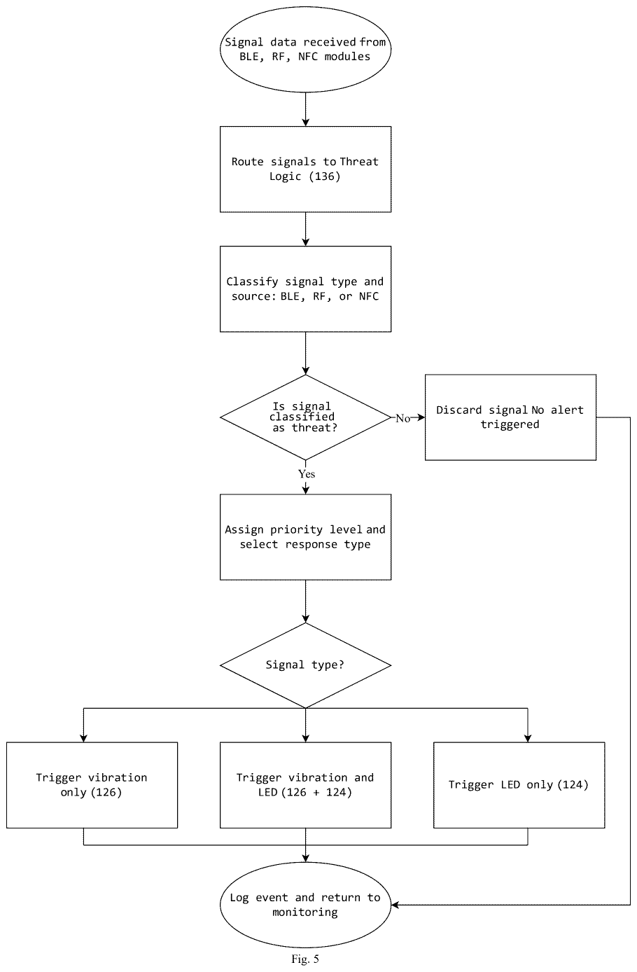

### FIG. 5

A threat classification logic diagram, demonstrating how signals are processed through modules 104, 106, 108, and analyzed by logic 136 to assign priority and threat level, which informs response behavior.

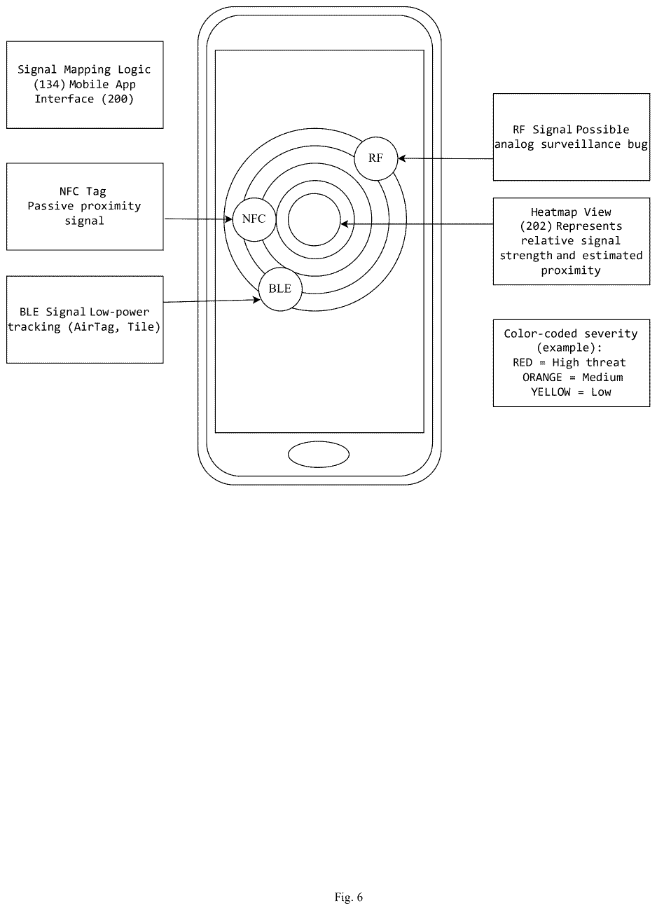

### FIG. 6

A user interface mock-up of the mobile application 200, including heatmap visualization module 202, signal mapping logic 134, and real-time alerts. Depicts graphical rendering of signal intensity to estimate proximity of BLE, RF, or NFC sources.

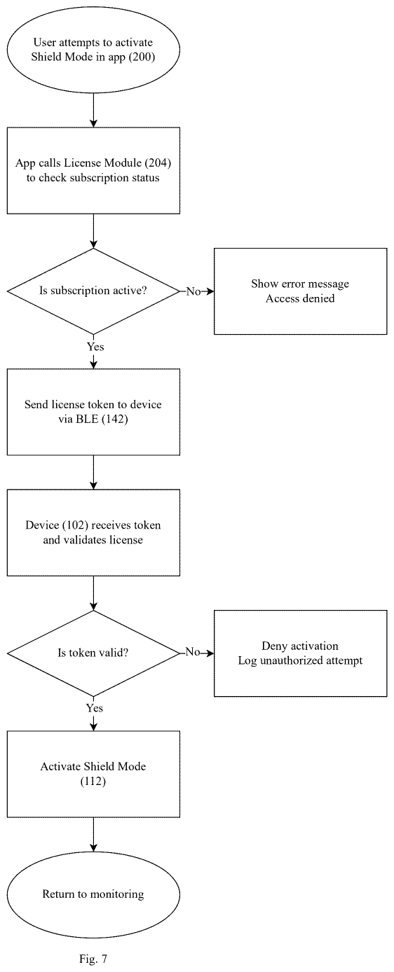

### FIG. 7

A flowchart illustrating the subscription entitlement and Shield Mode activation logic. The diagram shows the process flow starting from a user attempt in the mobile application (200), proceeding to a subscription status check by the license module (204), transmission of a valid license token via BLE (142), validation of the token by the device (102), and the subsequent activation of Shield Mode (112) or denial of the request.

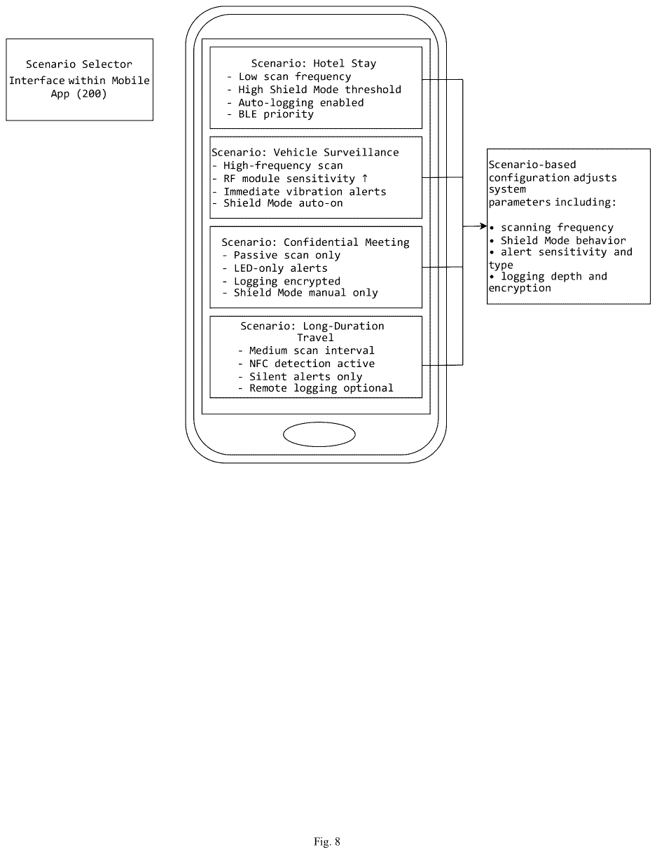

### FIG. 8

Mobile application screen layout representing scenario profile selection. Depicts modes for hotel stay, travel, meetings, etc., and the corresponding parameter bundles applied via configuration interface.

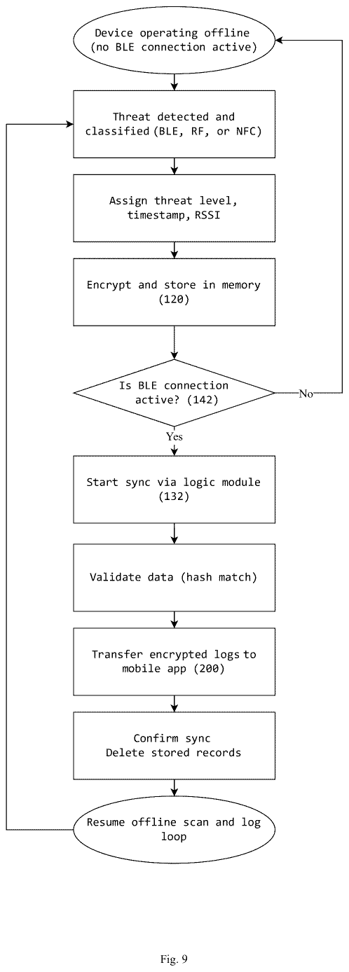

### FIG. 9

A data flow diagram showing encrypted event logging to internal memory 120, and subsequent synchronization process triggered via BLE module 142 and managed by synchronization logic 132, including integrity validation through hash comparison.

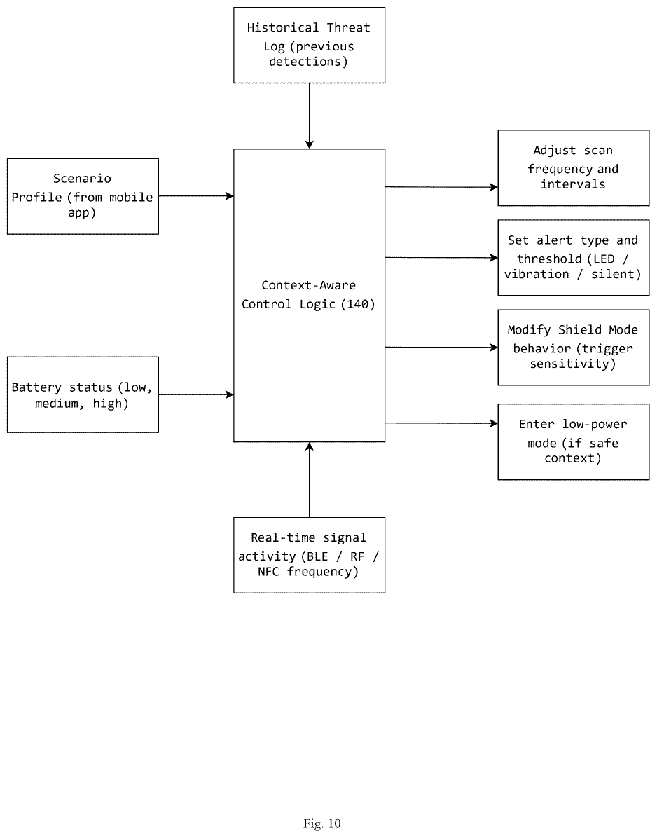

### FIG. 10

A system-level diagram showing context-aware operational control logic 140, dynamically adjusting scanning frequency, alert threshold, and countermeasure response based on user-defined scenarios, signal activity, and historical threat logs.

### 8. LIST OF REFERENCE NUMERALS (100-208)

The following reference numerals are used consistently throughout the figures and the detailed description to identify hardware components, functional modules, and interface elements of the invention.
100—Device enclosure/housing (key fob form factor)
102—Microcontroller (ESP32 with integrated BLE and Wi-Fi)
104—BLE scanning module
106—RF receiver module (433/868 MHz band)
108—NFC reader module
110—Ultrasonic emitter (20-24 kHz frequency range)
112—Protocol-conformant countermeasure module
114—Power management module (3.3V regulated output)
116—Rechargeable lithium-ion battery
118—USB-C charging port
120—Encrypted non-volatile memory (for local threat logs)
122—Physical button for Shield Mode activation
124—LED indicator (visual alert component)
126—Vibration motor (haptic alert component)
128—Real-time clock (RTC) module
130—OTA update module (BLE-based firmware delivery)
132—Log buffer and event queue
134—Heatmap signal estimator (for directional proximity logic)
136—Threat classification and signal analysis module
138—Signal filtering and false-positive rejection unit
140—Context-aware control logic
142—BLE synchronization and data transfer module
200—Mobile application (external software component)
202—Heatmap visualization interface
204—License verification module (app-side)
206—Shield Mode configuration interface (app-side)
208—Threat log viewer and incident history (app-side)

### 9. DETAILED DESCRIPTION OF THE INVENTION

The present invention is directed to a personal electronic device 100 configured to detect, classify, and provide protocol-conformant countermeasures against unauthorized wireless signals associated with digital surveillance.

The device is implemented in a compact enclosure having overall dimensions not exceeding approximately 75×45×20 mm, enabling portability and continuous personal deployment.

As shown in FIG. 1, the device comprises the following components:
a microcontroller 102, such as an ESP32, adapted to control system operations and coordinate signal scanning and response logic;
a Bluetooth Low Energy (BLE) scanning module 104 configured to detect BLE-based tracker signals, including but not limited to Apple AirTag, Tile, and similar devices;
a radio frequency (RF) receiver module 106, operable within at least one of the 433 MHz and 868 MHz frequency bands, configured to detect analog RF surveillance transmitters;
a near-field communication (NFC) reader module 108 configured to identify unauthorized proximity-based NFC reader activity and unauthorized tag access;
a signal filtering and false-positive rejection unit 138, configured to pre-process incoming data from scanning modules 104, 106, and 108 by removing spurious, reflected, or transient low-power signals prior to classification.

This logic enhances accuracy and reduces false alerts caused by environmental artifacts;
actuator components including a vibration motor 126 and an LED indicator 124, each operably connected to the microcontroller 102 for issuing local user alerts;
a physical activation button 122 mounted on the device housing and adapted to allow manual input from the user for initiating security actions;
an ultrasonic emitter 110 configured to generate acoustic masking signals in the 20 kHz to 24 kHz frequency range;
a protocol-conformant countermeasure module 112 configured to transmit standard-compliant wireless frames within regulatory limits in accordance with FCC Part 15;
a power system comprising a rechargeable lithium-ion battery 116, a USB-C charging port 118, and a power regulation module 114 configured to maintain voltage stability at operational levels; and
a BLE wireless communication module 142 configured to exchange encrypted metadata and control instructions with a mobile application 200.

The device is operable in at least two modes: (1) a passive detection mode and (2) an active protection mode referred to herein as Shield Mode.

In detection mode, the scanning modules 104, 106, and 108 continuously monitor the ambient environment for wireless activity.

Upon identification of a transmission matching a stored threat profile, the microcontroller 102 initiates a response sequence including activation of the vibration motor 126, the LED indicator 124, and the transmission of event data to the mobile application 200 via BLE interface 142, as depicted in FIG. 2.

### Control Logic Description (Block 140)

As used throughout this specification and the accompanying figures, block 140 is referred to as the “context-aware control logic 140.”

Subscription entitlement functionality is implemented as a subset of the context-aware control logic (140). Within this structure, the microcontroller (102) performs entitlement validation through interaction with the access control module (204) of the mobile application (200). The system enforces Shield Mode activation exclusively upon confirmation of a valid entitlement token, locally stored in encrypted form for offline validation where permitted.

This term collectively represents a unified set of software-driven functions implemented either within the primary microcontroller 102 or an associated sub-processor.

The context-aware control logic 140 is responsible for coordinating real-time operational behavior of the device, including mode transitions (e.g., between passive detection and Shield Mode), dynamic prioritization of responses based on threat severity, user scenario recognition, and adaptive power management.

Depending on the context of use (e.g., FIG. 3 vs. FIG. 10), the terminology may emphasize distinct aspects of this logic such as its scenario-aware behavior, its role in power and emission regulation, or its function in managing concurrent sub-system operations.

All such references pertain to the same integrated control entity.

### Shield Mode (Continuation of Detailed Description of the Invention)

As illustrated in FIG. 3, the device includes an active protection mode referred to as Shield Mode, wherein the system transitions from passive signal monitoring to a controlled countermeasure state.

Shield Mode may be activated by:
(a) manual input via the physical control button 122 located on the external housing 100; or
(b) a remote command issued by the paired mobile application 200 through the BLE communication module 142, subject to validation of an active subscription status via interface module 204.

Upon activation, the microcontroller 102 executes a protection sequence comprising:
activation of the ultrasonic emitter 110, configured to perform acoustic masking within the 20-24 kHz frequency range, intended to desensitize acoustic surveillance microphones; and
activation of the protocol-conformant countermeasure module 112, configured to transmit targeted, standard-compliant data packets that induce device-native safety responses in external wireless devices operating at threat-relevant frequency bands (e.g., 433 MHz and 868 MHz).

Each countermeasure module operates within pre-calibrated output parameters and is dynamically regulated by the power control module 114 to ensure compliance with applicable regulatory frameworks.

Specifically, the protocol-conformant countermeasure module 112 operates at low transmission power and within legal emission limits in accordance with FCC Part 15 Subpart C (47 CFR §§ 15.247 and 15.209).

Additionally, the countermeasure subsystems are designed in compliance with international emission standards, including CE EN 300 328, to permit lawful deployment in both U.S. and European regulatory zones.

For protocol-conformant interactions, the countermeasure module (112) transmits standard-compliant wireless frames that are designed to elicit device-native safety responses in third-party devices, where supported by the third-party device, while respecting guard intervals and emission duty-cycle limits consistent with the applicable regulatory profile. The module (112) enforces built-in guard intervals and maximum transmission duty-cycle per time window to ensure compliance with FCC Part 15 Subpart C and equivalent ETSI EN 300 328/220 regulations, thereby preventing receiver desensitization and maintaining lawful operation.

The module (112) is further constrained by firmware-enforced guard intervals and maximum emission duty-cycle per time window to guarantee compliance with emission limits and to prevent self-desensitization of the RF receiver (106).

Activation logic is governed by the embedded threat classification engine 136, which processes data from scanning modules 104, 106, and 108 to determine appropriate countermeasure parameters.

Shield Mode may operate in selective or combined countermeasure mode depending on detected signal type and severity.

Shield Mode is a time-limited operational state that may terminate automatically after a preset interval or be deactivated manually by the user via a secondary press of the control button 122. During Shield Mode, threat event data may be recorded in encrypted form to internal memory 120 and synchronized with the mobile application 200 upon session conclusion.

Interaction with the Mobile Application (Continuation of Detailed Description of the Invention)

As illustrated in FIGS. 6 and 10, the device is configured to interface with a mobile application 200 via the Bluetooth Low Energy (BLE) communication module 142. During the pairing and handshake process, the device transmits structured metadata comprising:
signal type classification (BLE, RF, or NFC);
received signal strength indication (RSSI);
timestamp of detection; and
assigned threat priority.

The mobile application comprises a graphical interface module 202 configured to display this data using heatmap-style visualizations and proximity-based indicators generated through signal mapping logic 134.

Additional features of the mobile application 200 include:
a log viewing module 208 configured to access encrypted historical data stored in memory 120;
a remote control interface 206 adapted to activate or deactivate Shield Mode based on subscription status;
a configuration interface for sensitivity adjustment and scenario profile selection;
a firmware update interface 130 for OTA updates; and
an access validation module 204 supporting PIN, biometric, and BLE-token-based authentication.

All communications between the device and the mobile application are secured using end-to-end AES-based encryption in compliance with NIST FIPS-197.

The context-aware control logic 140 enforces authentication and access control policies, ensuring that access to critical system functions including log viewing, configuration changes, and countermeasure activation is restricted to authenticated sessions only.

### Autonomous Operation and Data Protection (Continuation of Detailed Description of the Invention)

As illustrated in FIG. 10, the device is configured to operate in an autonomous mode without requiring an active or persistent connection to the mobile application 200. In this mode, the scanning subsystems including the BLE scanner 104, RF receiver 106, and NFC reader 108 operate continuously in the background to monitor for unauthorized or suspicious wireless transmissions.

Upon detection of a potential threat, the microcontroller 102 initiates local alerting through activation of the vibration motor 126 and/or LED indicator 124. Concurrently, threat-related metadata is stored in internal non-volatile memory 120, including but not limited to:
signal classification (BLE, RF, or NFC);
received signal strength indication (RSSI);
timestamp of detection; and
assigned threat severity level.

All data is encrypted using AES-256 encryption in accordance with NIST FIPS-197, executed locally through a secure embedded cryptographic module.

The encryption key is device-specific and stored in a protected memory partition inaccessible via external interfaces.

Access to the encrypted log data is permitted exclusively through an authenticated session initiated by the mobile application 200 following successful user identity verification via access control module 204.

Upon reestablishment of BLE communication, the device initiates a secure data synchronization process managed by BLE module 142 and synchronization logic 132. This process includes integrity validation and duplication prevention using internal hashing and entry comparison algorithms to ensure complete and accurate data transfer.

The autonomous mode is particularly adapted for use in environments with limited or restricted connectivity, including but not limited to air travel, high-security facilities, and international transit.

The device ensures that all relevant surveillance events are retained and protected until a secure connection becomes available.

### Firmware Updates, Subscription, and Expandability (Continuation of Detailed Description of the Invention)

As illustrated in FIGS. 8 and 10, the device supports secure over-the-air (OTA) firmware updates transmitted from the paired mobile application 200 via the BLE communication module 142. Firmware updates are managed by the OTA update module 130 and executed without physical interaction with the device.

The update mechanism allows for modification of operational logic, inclusion of new threat detection protocols, and expansion of feature sets.

Over-the-air update packages delivered via module (130) are authenticated by verifying a cryptographic signature and validating a hash-based integrity check prior to selectively overwriting modular firmware components.

The embedded firmware is implemented as a modular software architecture, wherein discrete functions including signal scanning, user alerting, countermeasure deployment, and Shield Mode 112 are developed as independent code units.

These modules are selectively invoked and managed by the microcontroller 102, allowing dynamic configuration based on environmental input, user profile, or threat classification.

Heatmap-generation logic (134) is executable firmware configured to transform time-aligned RSSI samples (received from the microcontroller 102) into a relative proximity field both for on-device preview and for the mobile application (200). Logic (134) consumes motion-correlated timestamps and RSSI gradients and outputs a normalized scalar field used by the mobile interface (202) to render a color-gradient heatmap. This logic operates autonomously without reliance on external geolocation sources, including GPS, Wi-Fi, or UWB positioning.

Access to certain functions, including Shield Mode, is controlled by subscription entitlement logic implemented within the firmware and validated through the mobile application 200 via access control module 204.

Activation of Shield Mode 112 is permitted only upon successful authentication of an active license. In the event of a failed validation attempt, access is denied, a user notification is issued via the mobile interface 206, and the incident may be logged for audit purposes.

The system further enables scenario-based configuration profiles adapted for different environments, including but not limited to:
temporary deployment in hotels, vacation rentals, and shared accommodations;
protection of confidential meetings, secure communications, and sensitive discussion zones; and
high-security mobility scenarios such as travel, transit, and field operations.

By integrating OTA upgradability with a modular firmware structure and scenario-driven adaptability, the device is scalable for deployment across a range of user categories, including personal, family, professional, and high-security domains.

The system further supports user-defined scenario profiles that adapt operational parameters to different environments and privacy risk levels. Each scenario profile is defined by configuration bundles specifying scanning frequency, alert thresholds, countermeasure intensity, and data logging policies, allowing the device to automatically optimize its behavior without user intervention.

Example scenarios include: (a) private lodging environments such as hotels, vacation rentals, and shared accommodations; (b) confidential or restricted meetings, including corporate boardrooms and secure communication zones; and (c) high-mobility or travel conditions such as airports, transit, and cross-border operations.

Each configuration profile is stored locally within encrypted non-volatile memory 120 and can be updated remotely through the mobile application 200 via the configuration interface 206. Profiles may be extended or customized through OTA firmware updates, allowing continuous refinement of detection and countermeasure algorithms as new wireless surveillance technologies emerge.

By integrating OTA upgradability, modular firmware design, subscription entitlement logic, and scenario-driven adaptability, the present invention establishes a scalable platform for privacy protection applicable across personal, professional, and high-security domains.

The device thereby provides a comprehensive, lawful, and context-aware defense framework against modern wireless surveillance threats.

### 10. REGULATORY COMPLIANCE STATEMENT

The present invention is configured and designed to operate within the scope of applicable regulatory and legal standards for wireless communication, protocol-conformant countermeasures, and data encryption.

Specifically:

For 2.4 GHz Bluetooth Low Energy transmissions, the device is configured to comply with FCC Part 15 Subpart C emission and operation requirements applicable to BLE radios (including § 15.247/§ 15.249, as implemented by the chosen radio), and with ETSI EN 300 328 within the European Union.

For sub-GHz operation in the 433/868 MHz bands, the device is configured to comply with the applicable limits under FCC Part 15 (including § 15.231 and/or § 15.209, as applicable) within the United States, and with ETSI EN 300 220 within the European Union.

All RF emissions are engineered to avoid harmful interference and are governed by firmware-enforced guard intervals, maximum duty-cycle windows, and output-power constraints derived from the applicable rule set for the active band and jurisdiction.

Firmware enforces band-specific EIRP ceilings and emission duty-cycle limits consistent with the applicable FCC/ETSI profile for (i) BLE at 2.4 GHz and (ii) sub-GHz operation (433/868 MHz), with guard intervals to prevent receiver self-desensitization and to maintain compliance across region-specific profiles.

### 11. ADVANTAGES OVER THE PRIOR ART

The present invention provides a multifunctional personal electronic device that integrates detection, classification, and deployment of protocol-conformant countermeasures against unauthorized wireless surveillance signals within a compact and consumer-accessible form factor.

The device offers multiple technical and practical advantages not found in existing solutions, including but not limited to:
Multimodal scanning capability across BLE, analog RF, and NFC channels in a unified detection sequence managed by a central microcontroller;
Legally compliant active countermeasures, including acoustic masking via an ultrasonic module and protocol-conformant countermeasures via an RF module, operating within FCC and CE emission standards without generating harmful interference;
Real-time signal analysis and classification, with prioritized alerting and threat-severity scoring performed locally;
Encrypted autonomous logging of detected events in non-volatile memory using AES-256 in compliance with NIST FIPS-197, with delayed synchronization supported;
Subscription-locked access, managed via subscription entitlement logic, to active countermeasure features (Shield Mode), including authentication and usage restriction logic;
Secure mobile application integration, offering directional visualizations, remote control, OTA firmware upgrades, and scenario-specific profile management;
Modular firmware architecture supporting adaptive updates and profile expansion without hardware replacement.

These capabilities, when considered in combination, provide a novel and non-obvious solution that addresses unmet needs in privacy protection and wireless surveillance countermeasures.

1-20. (canceled)

21. A portable personal electronic device for detecting and counteracting unauthorized wireless surveillance signals, comprising: a compact housing; a microcontroller configured to manage device operations and execute threat analysis locally to maintain user privacy; a Bluetooth Low Energy (BLE) communication module; a radio frequency (RF) receiver module operable at least in the 433 MHz and/or 868 MHz bands; an NFC reader module; a user alert interface comprising a vibration actuator and an LED indicator; a physical control button; an acoustic masking module; a protocol-conformant countermeasure module; an encrypted non-volatile memory; and a power management module; wherein the device is configured to: (a) scan BLE, RF, and NFC signals and classify threats based on predefined rule sets stored in the memory; (b) activate a protective operational state (“Shield Mode”) subject to subscription entitlement validation; wherein, in said Shield Mode: the acoustic masking module generates ultrasonic signals in a frequency range configured to exploit non-linearities of microphones (e.g., approximately 20-24 kHz) to desensitize microphones; and the protocol-conformant countermeasure module transmits targeted wireless frames selectively addressed to identified threats configured to induce device-native safety responses in external wireless devices, within regulatory emission limits and without generating harmful broadband interference.

22. The device of claim 21, wherein activation of said Shield Mode is gated by subscription entitlement logic enforced by the microcontroller, wherein the microcontroller is configured to deny Shield Mode activation when a valid entitlement token is absent or expired, and wherein the device stores an encrypted offline entitlement token in the memory to allow time-limited offline validation.

23. The device of claim 21, wherein the BLE communication module transmits threat metadata including signal type and RSSI to a paired mobile application, and wherein the device provides data to enable said mobile application to render a relative proximity heatmap based on temporal gradients of RSSI correlated with user motion, without reliance on GPS, UWB, Wi-Fi triangulation, or cellular positioning.

24. The device of claim 21, wherein the microcontroller classifies detected signals by executing a threat analysis rule set that includes analysis of at least one of:
advertising frame structure, manufacturer identifiers, dynamic address-rotation patterns, duty-cycle anomalies, and cross-channel co-occurrence, to distinguish surveillance devices from benign electronics.

25. The device of claim 21, configured to operate in an autonomous mode wherein the device issues local alerts via the vibration actuator or LED indicator and stores structured event data including signal type, timestamp, and threat level in the encrypted non-volatile memory using AES-based encryption, and automatically synchronizes said data with a mobile application upon re-establishing a secure BLE connection.

26. The device of claim 21, wherein a behavioral filtering algorithm executed by the microcontroller analyzes frequency, duration, and repetition of detected signals to deprioritize benign patterns based on historical context, thereby reducing false positive alerts.

27. The device of claim 21, wherein access to restricted functions, including viewing encrypted logs and configuring Shield Mode parameters, is secured by multi-factor authentication involving at least one of a PIN, biometric verification, or a cryptographic digital token exchanged via BLE.

28. The device of claim 21, further comprising an Over-the-Air (OTA) update module, wherein the microcontroller is configured to verify a cryptographic signature of firmware update packets received via the BLE communication module prior to applying updates to the acoustic masking module or the protocol-conformant countermeasure module.
